(19) United States
(12) Patent Application Publication
(10) Pub. No.: US 2014/0040433 A1
(43) Pub. Date: Feb. 6, 2014

(54) MECHANISM FOR FACILITATING REAL-TIME STREAMING, FILTERING AND ROUTING OF DATA

(71) Applicants: DANIEL DALE RUSSELL, JR., Campbell, CA (US); Brian C. Knox, Richmond, VA (US)

(72) Inventors: DANIEL DALE RUSSELL, JR., Campbell, CA (US); Brian C. Knox, Richmond, VA (US)

(73) Assignee: Talksum, Inc., San Francisco, CA (US)

(21) Appl. No.: 13/954,359

(22) Filed: Jul. 30, 2013

Related U.S. Application Data
(60) Provisional application No. 61/678,895, filed on Aug. 2, 2012.

(51) Int. Cl. H04L 29/06

(52) U.S. Cl. CPC H04L 65/60
USPC 709/219; 707/600

(57) ABSTRACT

In accordance with embodiments, there are provided mechanisms for facilitating real-time streaming, filtering and routing of data according to one embodiment. In one embodiment and by way of example, a method includes receiving, at a computing device, one or more data streams from one or more data sources, transforming, in real-time, the one or more data streams into one or more normalized data streams. The transforming includes performing ingestion of the one or more data streams. The method may further include filtering, in real-time, the one or more normalized data streams, and routing the one or more filtered data streams as real-time output to one or more data systems.

### CLAIM OF PRIORITY

This application claims priority to and the benefit of U.S. Provisional Patent Application No. 61/678,895, entitled “A Method for Real Time Data Streaming, Filtering and Routing” by Daniel Dale Russell, et al., filed Aug. 2, 2012, the entire contents of which are incorporated herein by reference.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### TECHNICAL FIELD

One or more implementations relate generally to data management and, more specifically, to a mechanism for facilitating real-time streaming, filtering and routing of data.

### BACKGROUND

With the increasing use of the Internet, mobile computing devices, digital technology, etc., the expansion of data volumes has been a noteworthy trend in the global technology arena. For example, by some estimates, the current volume of total data in the world is about 2.7 ZB, about 18 million Libraries of Congress, and is expected to grow about 40-60% annually. Further, not only the data volume is increasing, but the variety and frequency of the data is also rapidly increasing which leads to a number of problems and challenges relating to data management, such as with regard to data generation, data analysis, data speed that is compatible with today's technologies, data storage, etc. Accordingly, the conventional paradigm of storing data in structured databases does not meet today's expanding needs of data consumption nor can it accommodate unstructured data. Similarly, more traditional software application based approaches that rely on being part of a large middleware stack do not make efficient enough use of computing resources to scale efficiently.

### BRIEF DESCRIPTION OF THE DRAWINGS

In the following drawings like reference numbers are used to refer to like elements. Although the following figures depict various examples, one or more implementations are not limited to the examples depicted in the figures.

FIG. 1 illustrates a computing device employing a mechanism for facilitating real-time streaming, filtering and routing of data according to one embodiment;

FIG. 2 illustrates a mechanism for facilitating real-time streaming, filtering and routing of data according to one embodiment according to one embodiment;

FIG. 3 illustrates an architecture overview of a data system employing a mechanism for facilitating real-time streaming, filtering and routing of data according to one embodiment according to one embodiment;

FIG. 4 illustrates an extended platform architecture of a data system employing a mechanism for facilitating real-time streaming, filtering and routing of data according to one embodiment according to one embodiment;

FIG. 5A illustrate a simplified services architecture of a data system employing a mechanism for facilitating real-time streaming, filtering and routing of data according to one embodiment according to one embodiment;

FIG. 5B illustrate a simplified services architecture of a data system employing a mechanism for facilitating real-time streaming, filtering and routing of data according to one embodiment according to one embodiment;

FIG. 6A illustrates a method for facilitating real-time streaming, filtering and routing of data using data mechanism according to one embodiment.

FIG. 6B illustrates a method for facilitating real-time streaming, filtering and routing of data using data mechanism according to one embodiment.

FIG. 7 illustrates a computer system according to one embodiment.

### DETAILED DESCRIPTION

In the following description, numerous specific details are set forth. However, embodiments, as described herein, may be practiced without these specific details. In other instances, well-known circuits, structures and techniques have not been shown in details in order not to obscure the understanding of this description.

Methods and systems are provided for facilitating real-time streaming, filtering and routing of data according to one embodiment. In one embodiment and by way of example, a method includes receiving, at a computing device, one or more data streams from one or more data sources, transforming, in real-time, the one or more data streams into one or more normalized data streams. The transforming includes performing ingestion of the one or more data streams. The method may further include filtering, in real-time, the one or more normalized data streams, and routing the one or more filtered data streams as real-time output to one or more data systems.

Embodiments provide a mechanism (e.g., routing system) for transforming data into information streams to gain a new measure of control and visibility. In one embodiment, the data is passed through a single simple to manage routing system (e.g., Talksum™ Stream Router), resulting in simplification and increased efficiency of data integration, extract transform load (ETL) processes, and data management across multiple initiatives, while reducing server footprint and increasing agility for data initiatives. Further, embodiment provide for gaining real-time analytics capabilities through real-time dashboard monitoring of critical operational, while providing a full set of user interfaces and software development kits (SDKs) through a self-service platform for facilitating higher control and better customization abilities for users (e.g., system administrator, end-user, etc.).

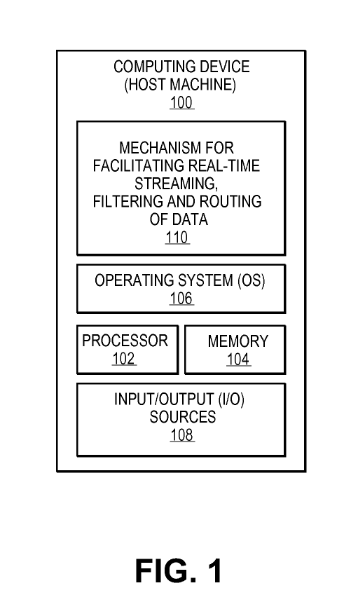

FIG. 1 illustrates a computing device 100 employing a mechanism 110 for facilitating real-time streaming, filtering and routing of data according to one embodiment. In one embodiment, computing device 100 serves as a host machine employing a mechanism for facilitating real-time streaming, filtering and routing of data (“data mechanism”) 110. Computing device 100 may include server computers (e.g., cloud server computers, etc.), desktop computers, cluster-based computers, set-top boxes (e.g., Internet-based cable television set-top boxes, etc.), and the like. Data mechanism 110 may be itself be an operating system or referred to as a router or be part of operating system (OS) 106 or associated with OS 106 to use any number and type of OS-based components to transform data into normalized event streams while applying filtering and routing rules to them in real-time. By utilizing the operating system-level efficiencies, significantly higher rates of data ingest, transformation, and processing may be achieved in comparison to any of the existing technologies and techniques. Further, it is contemplated that various terms, such as “data mechanism”, “Talksum Data Stream Router”, “routing system”, “operating system” and the like, may be used interchangeably throughout the document.

Computing device 100 may also include smaller computers, such as mobile computing devices, such as cellular phones including smartphones (e.g., iPhone® by Apple®, BlackBerry® by Research in Motion®, etc.), handheld computing devices, personal digital assistants (PDAs), etc., tablet computers (e.g., iPad® by Apple®, Galaxy® by Samsung®, etc.), laptop computers (e.g., notebooks, netbooks, Ultrabook™, etc.), e-readers (e.g., Kindle® by Amazon.com®, Nook® by Barnes and Nobles®, etc.), Global Positioning System (GPS)-based navigation systems, etc.

Computing device 100 includes OS 106 serving as an interface between any hardware or physical resources of the computing device 100 and a user. Computing device 100 further includes one or more processors 102, memory devices 104, network devices, drivers, or the like, as well as input/output (I/O) sources 108, such as touchscreens, touch panels, touch pads, virtual or regular keyboards, virtual or regular mice, etc. It is to be noted that terms like “node”, “computing node”, “server”, “server device”, “cloud computer”, “cloud server”, “cloud server computer”, “machine”, “host machine”, “device”, “computing device”, “computer”, “computing system”, and the like, may be used interchangeably throughout this document. It is to be further noted that terms like “application”, “software application”, “program”, “software program”, “package”, and “software package” may be used interchangeably throughout this document. It is to be noted that the use of certain terms, such as “Talksum”, “Talksum Data Stream Router”, “TalkOS broker”, “Talksum broker”, etc., should not be read to limit embodiments to software or devices that carry that label in products or in literature external to this document.

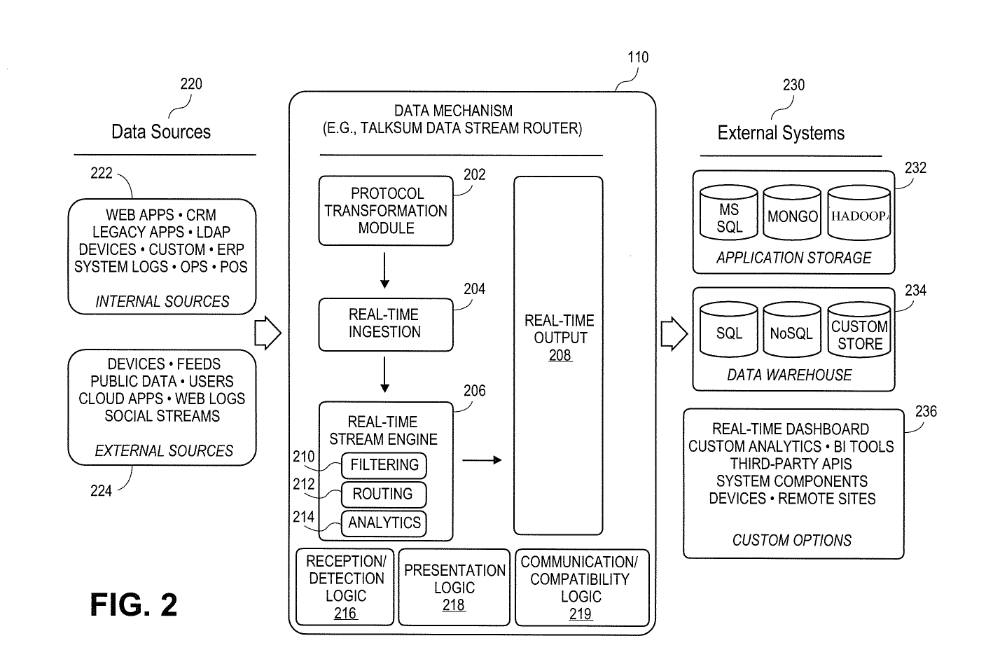

FIG. 2 illustrates a mechanism 110 for facilitating real-time streaming, filtering and routing of data according to one embodiment according to one embodiment. In one embodiment, data mechanism 110 may include various components, such protocol transformation module 202, real-time ingestion module 204, and real-time stream engine 206. Data mechanism 110 may further include any number and type of sub-components such a real-time stream engine 206 may include filtering module 210, routing module 212, analytics module 214, etc. Similarly, data mechanism 110 may include other components, such as reception/detection logic 216, presentation logic 218, and communication/compatibility logic 219, etc., to perform other relevant tasks.

In some embodiments, data mechanism 110 may be in communication with any number and type of databases to store any type and amount of content including data, metadata, tables, reports, etc., relating to messaging queues, etc., and may be further in communication with any number and type of client computing devices over a network (e.g., Internet, cloud network, etc.). Throughout this document, terms like “logic” and “module” may be used interchangeably and further may be interchangeably referred to as “framework” or “component” and may include, by way of example, software, hardware, and/or any combination of software and hardware, such as firmware.

In one embodiment, data mechanism 110 may receive data from any number and type of data sources 220, such as internal sources 222 (e.g., Web applications, legacy applications, system logs, customer relationship management (CRM) data sources, etc.) and external sources 224 (e.g., computing devices, public data, cloud applications, social streams, etc.). The received data is then managed and processed by data mechanism 110 and provided to external systems 230, such as application storage devices 232, data warehouse 234, and custom outputs 236 (e.g., real-time dashboards, remote sites, third-party application programming interfaces (APIs), etc.).

Transformation module 202, in one embodiment, may utilize native operation system logging system to handle the intake of data from data sources 220 via a variety of protocols, such as Transmission Control Protocol (TCP), User Datagram Protocol (UDP), Reliable Event Logging Protocol (RELP), ZeroMQ, File, Unix Socket, Kernel Logging, and File Transfer Protocol (FTP), etc. Transformation module 202 may further retain a library of parsing rules based on various formats which is then injected into a logging system. Transformation module 202 may retain a library of output templates for the purpose of adding or modifying the data structure being processed as well as for adding required metadata for the efficient processing by downstream modules in the system. Further, transformation module 202 is used to enable the management of unstructured data through a combination of managing the intake as a function of native logging and an addition of structure and metadata through the parsing rules. In one embodiment, transformation module 202 may include a parser to parse the data, wherein transformation module 202 passes the transformed and parsed data into an event streaming data bus in the form of individually transformed data points in a normalized format through the use of a message queue in a queue system.

In one embodiment, transformation module 202 may include a protocol transformation module and a protocol to facilitate real-time ingestion module 204 to perform ingestion processes that include working with the operating system to ingest data from any potential sources and transform it into a single commonly accepted protocol. Further, the parser of transformation module 202 may parse the variegated data into the common protocol for being able to apply various techniques to the downstream processes.

The event streaming data bus associated with real-time stream engine 206 may utilize the queue system to stream previously transformed data as individual events, making them available for other functions of the system. The event streaming data bus is further to provide endpoints for other system service modules, such as monitoring, filtering, alerting, user interface, etc., to support the core functions of the system. The event streaming data bus is based on real-time stream engine 206 and may include one or more of core and object router technologies, such as Talksum core router, Talksum object router, etc., to facilitate the operating system to take the data that has been transformed by transformation module 202 into a common protocol and break the data points into individual events. The data is thus transformed into dynamic event streams that can be managed and processed in real-time.

In one embodiment, filtering and analytics modules 210 and 214 of real-time stream engine 206 may allow for a real-time filter to be set against the streaming event data by enabling its monitoring logic to view the normalized event stream data in a configurable fashion. Further, filtering and analytics modules 210 and 214 enable triggering of actions based on filters and may include a trigger type that enables the aggregation of counts and statistics that are made available for user interface presentation (e.g., real-time dashboard of custom outputs 236) or programmatic access by a statistics and/or analytics services. Other trigger types may include a trigger type that enables recognition of complex patterns in real-time data through a method of aggregated filtering by filtering module 210, a trigger type that enables altering based on defined conditions, and a trigger type that activates a routing rule and send the event data to a specific storage output or external system based on the routing and output rules specified by the downstream service.

In one embodiment, routing module 212 may route events and event data to external systems 230 based on configurable routing logic based on the normalized event stream data. Routing module 212 may also support the routing to event data to internal systems for the purposes of internal storage and processing between services when and where necessitated. Some of the storages may include data warehouse 234, such as Sequential Query Language (SQL) database, custom store, etc. Routing module 212 may utilize internal memory to serve event data, real-time output 208, until downstream external systems 230 are able to consume it. Further, routing module 212 provides configurable queues to allow for message overflow if the downstream external system 230 is not available and further provides configuration buffer sizes to ensure that memory is allocated to accommodate queue size and downstream external system performance.

In one embodiment, data mechanism 110 facilitates output and storage management of real-time output 208 of data by transforming normalized event data into alternative formats as necessitated by downstream external storage or processes and by allowing the configuration of the output format of real-time output 208 by leveraging the normalized format and transformation capabilities of the system. Further, indexes critical system data and real-time operational data of real-time output 208 may be used and placed into an internal high-speed storage. The output and storage management may make indexed internally saved data accessible to both internal system services, such as data warehouse 234, as well as external applications, such as application storage 232. Further, the output and storage management outputs indexed data of real-time output 208, as needed, for external storage solutions of external systems 230, allowing for the efficient use of existing external storage solutions in any number and type information technology (IT) infrastructures.

Data mechanism 110 may perform hardware utilization by using an operating system kernel that has been minimized to those limited hardware interfaces that are utilized by the system, maximizing efficiency of kernel operations. Further, data mechanism 110 utilizes high-speed storage for critical system and operational data, and utilizes in-memory processing for real-time optimization of data management efficiency.

In one embodiment, reception/detection logic 216 may be used to receive or detect various requests (e.g., user requests for data, etc.), data, data changes, etc., so that the relevant data may be chosen to be processed and managed. Presentation logic 218 may be used to facilitate presentation or display of data (e.g., real-time output 208) for an end user or an administrative user (e.g., system administrator, software programmer, etc.) in response to a user request. The data from real-time output 208 may be displayed at a client computing device via a user interface (e.g., Graphical User Interface (GUI)-like interface, Web browser, etc.), where the displaying of the data may be facilitated using an end-user interface layer of presentation logic 218.

Communication/configuration logic 219 may facilitate the ability to dynamically communicate and stay configured with various types and forms of data (e.g., media content files, communication data, etc.). Communication/configuration logic 219 further facilitates the ability to dynamically communicate and stay configured with various types and forms of computing devices, such as server computing device 100 of FIG. 1, client computing devices (e.g., mobile computing devices, such as various types of smartphones, tablet computers, laptops, etc.), networks (e.g., Internet, cloud-computing network, etc.), websites (e.g., social networking websites, such as Facebook®, LinkedIn®, Google+®, etc.), etc., while ensuring communication and compatibility with changing technologies, parameters, protocols, standards, etc.

It is contemplated that any number and type of components may be added to and/or removed from data mechanism 110 to facilitate various embodiments including adding, removing, and/or enhancing certain features. For brevity, clarity, and ease of understanding of data mechanism 110, many of the standard and/or known components, such as those of a computing device, are not shown or discussed here. It is contemplated that embodiments are not limited to any particular technology, topology, system, architecture, and/or standard and are dynamic enough to adopt and adapt to any future changes.

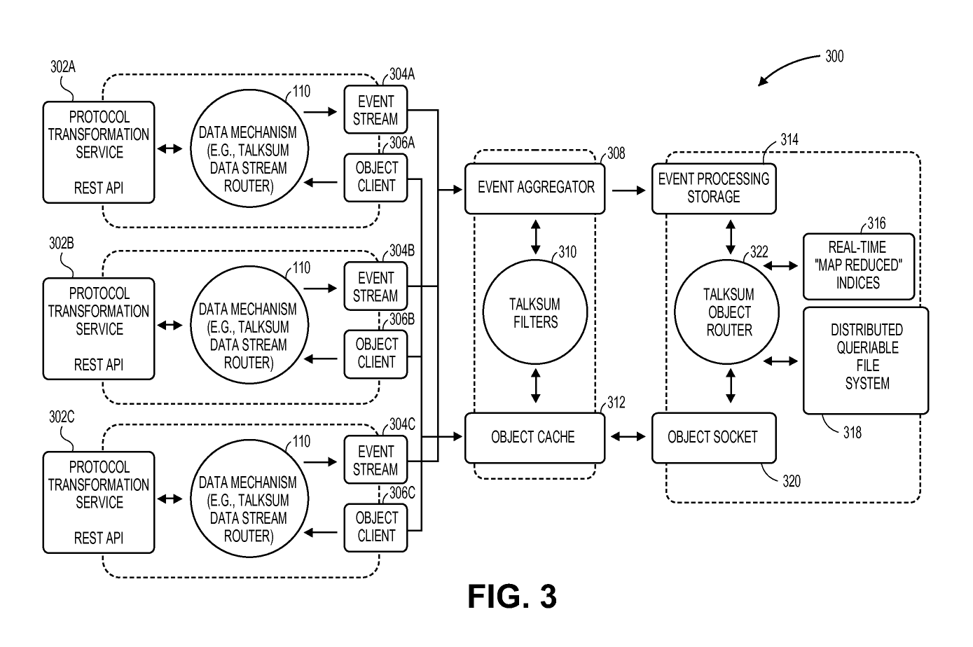

FIG. 3 illustrates an architecture 300 overview of a data system employing a mechanism 110 for facilitating real-time streaming, filtering and routing of data according to one embodiment according to one embodiment. In one embodiment, data mechanism 110 (e.g., Talksum data stream router) may be employed for data processing and management in communication with protocol transformation services 302A-302C (e.g., rest APIs) to provide event data streams 304A-304C and receive object clients 306A-306C. Data from data event stream 304A-306A and object clients 306A-306C is filtered using filters 310 and communicated with event processing storage 308 and object socket 312, respectively. The data is then routed via object router 322 and using real-time indices 316 (e.g., map reduced indices) and distributed queriable file system 318.

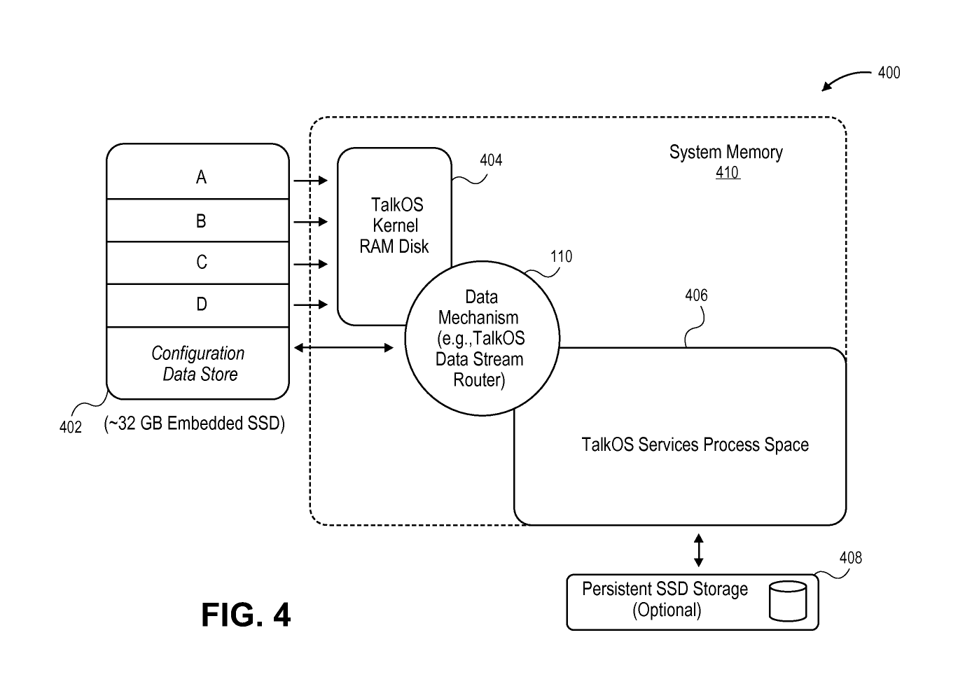

FIG. 4 illustrates an extended platform architecture 400 of a data system employing a mechanism 110 for facilitating real-time streaming, filtering and routing of data according to one embodiment according to one embodiment. In the illustrated embodiment, data mechanism 110 (e.g., TalkOS data stream router) is employed a part of system memory 410 for processing and management of data being used by and communicated between configuration data store 402 and kernel random access memory (RAM) disk 404 (e.g., TalkOS kernel RAM disk) and services process space 406 (e.g., TalkOS services process space) of system memory 410. The data may be further communicated with persistent data storage device 408 (e.g., solid state derive (SSD) storage).

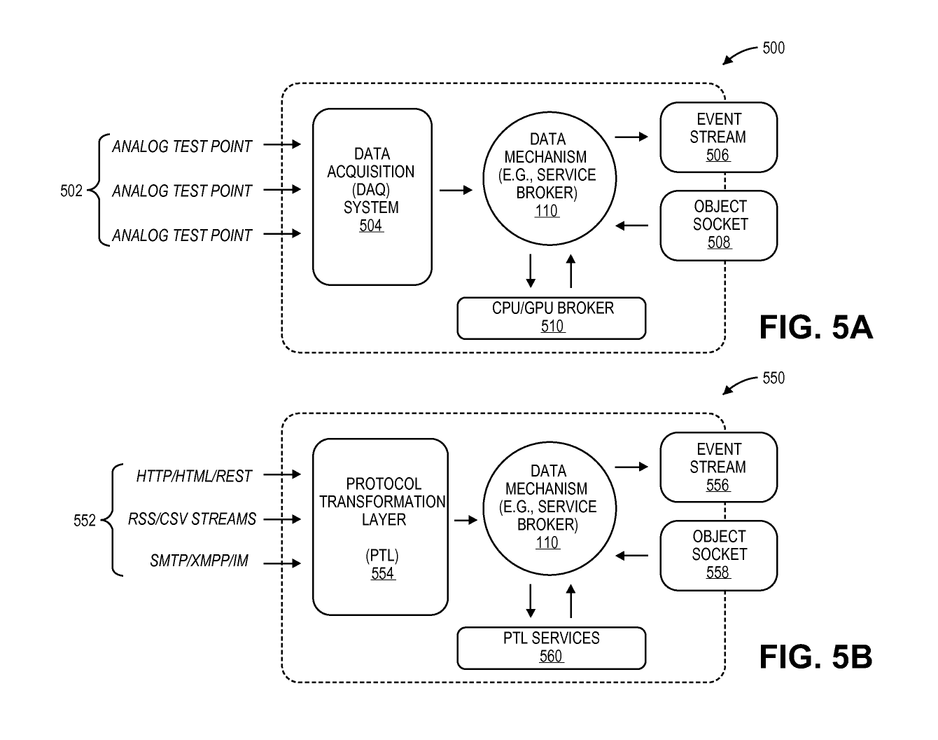

FIG. 5A illustrate a simplified services architecture 500 of a data system employing a mechanism 110 for facilitating real-time streaming, filtering and routing of data according to one embodiment according to one embodiment. In the illustrated embodiment, data may be communicated through data acquisition (DAQ) system 504 for data acquisition sampling of analog signals or waveforms received from any number of analog test points 502. The sampling process may include measuring real world physical conditions and converting the sample results of analog waveforms into digital numeric values that can be used by and processed by data mechanism 110 (e.g., service broker). DAQ system 504 may include a number of components, such as sensors to convert physical parameters to electrical signals, signal conditioning circuitry to convert signals into a form that can then be converted into digital values, and analog-to-digital converters to convert conditioned sensor signals to digital values.

In one embodiment, the converted data is then processed and brokered through data mechanism 110 (e.g., service broker) and communicated as event data stream 506 back from object socket 508 and further communicated with central processing unit (CPU)/graphical processing unit (GPU) broker 510.

FIG. 5B illustrate a simplified services architecture 550 of a data system employing a mechanism 110 for facilitating real-time streaming, filtering and routing of data according to one embodiment according to one embodiment. In the illustrated embodiment, data is received at protocol transformation layer (PTL) 554 from any number and types of protocol streams 552 (e.g., HyperText Transfer Protocol (HTTP)/HyperText Markup Language (HTML)/Representational State Transfer (REST) stream, Rich Site Summary (RSS)/Comma-separated values (CSV) stream, Simple Mail Transfer Protocol (SMTP)/Extensible Messaging Presence Protocol (XMPP)/Instant Messaging (IM) stream, etc.) that are then brokered using data mechanism 110 (e.g., service broker) and communicated between PTL services 560, event data stream 556, and object socket 558.

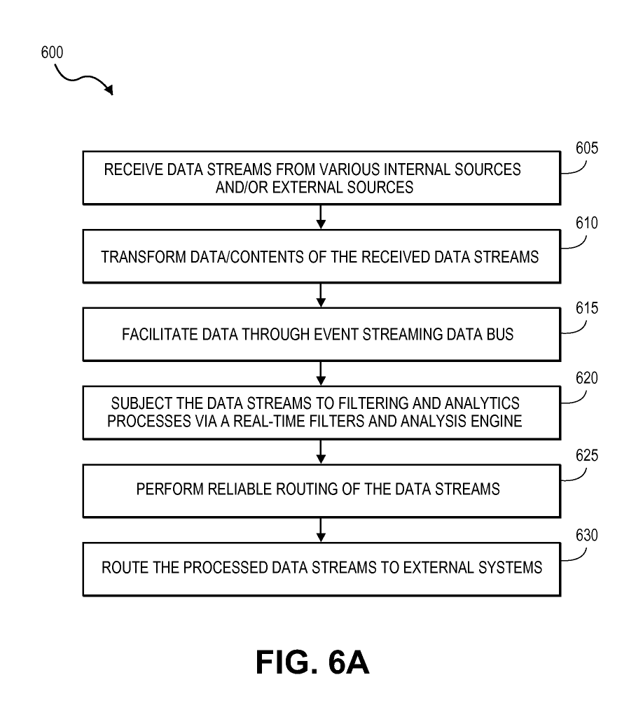

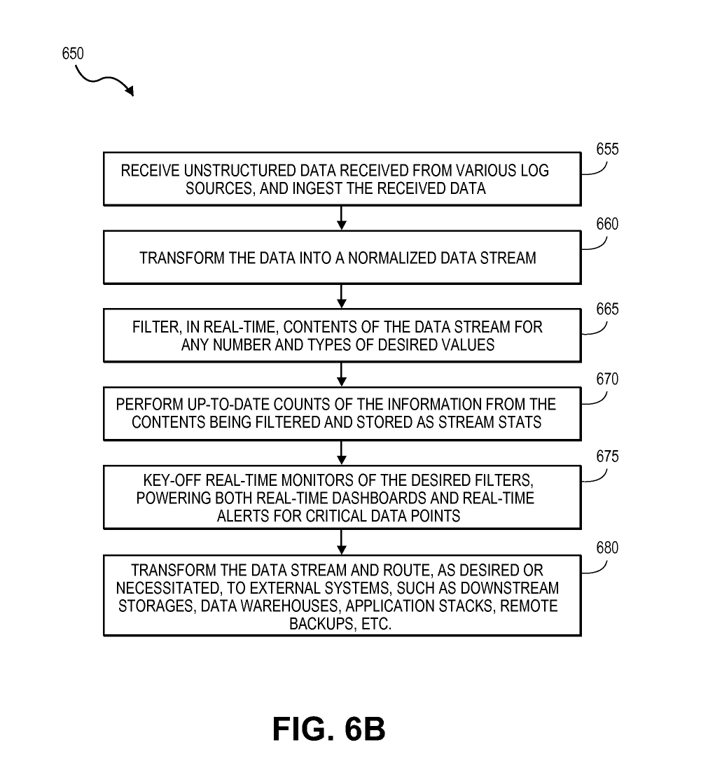

FIG. 6A illustrates a method 600 for facilitating real-time streaming, filtering and routing of data using data mechanism 110 according to one embodiment. Method 600 may be performed by processing logic that may comprise hardware (e.g., circuitry, dedicated logic, programmable logic, etc.), software (such as instructions run on a processing device), or a combination thereof. In one embodiment, method 600 may be performed by data mechanism 110 of FIG. 1.

In one embodiment, data mechanism 110 (e.g., Talksum Data Stream Router) provides for handling of massive volumes of data in real-time using various native components of an operating system, such as in-memory processing, kernel level technologies, cutting edge hardware, etc. At block 605, data streams are received from various internal sources (e.g., Web applications, CRM, Legacy applications, etc.) and/or external sources (e.g., computing devices, feeds, public data, cloud applications, Web logs, social streams, etc.). In one embodiment, real-time monitoring of data is performed including receiving any of the aforementioned data streams. At block 610, data/contents of the received data streams are transformed, where transformation of data includes ingestion and parsing of structured and/or unstructured data, normalization of data format for processing and analysis, and adding of metadata for efficient indexing and alerting.

At block 615, data is facilitated through event streaming data bus, where dynamic streams are created from the data inputs as well as various triggers, alerts, and monitors are enabled, making the data immediately actionable. At block 620, the data streams are made subject to filtering and analytics processes using real-time filters and analysis engine. The filtering and analytics processes may include performing real-time pattern recognition and counting and facilitating custom analytics capabilities to users via analytics real-time dashboard interfaces and user experience (UX) APIs, etc. At block 625, using the real-time stream engine, reliable routing of the data streams is performed, wherein the process of reliable routing includes performing flexible output configuration to send data to other systems, as desired or necessitated, establishing configurable queues and buffers to ensure transactional integrity of the data streams, and guarding against any data loss while optimizing resource utilization. At block 630, the processed data streams are provided to various external systems, such as application storages, data warehouses, and custom outputs, etc. For example, data may be displayed to a user via a display device at a client computing device (e.g., a mobile computing device) via a user interface of a real-time dashboard, etc. The real-time dashboard may also be used by the user to facilitate monitoring of data, including any incoming data streams.

In one embodiment, indexed “fast storage” layer may be provided for native real-time access to critical data, while providing increased efficiency for existing storage resources and supporting existing data warehousing while adding real-time layer. In one embodiment, latest operating system functionalities and network technologies may be used, including flash storages, SSDs, in-memory processing of data streams, etc.

FIG. 6B illustrates a method 650 for facilitating real-time streaming, filtering and routing of data using data mechanism 110 according to one embodiment. Method 650 may be performed by processing logic that may comprise hardware (e.g., circuitry, dedicated logic, programmable logic, etc.), software (such as instructions run on a processing device), or a combination thereof. In one embodiment, method 650 may be performed by data mechanism 110 of FIG. 1.

In one embodiment, data mechanism 110 (e.g., Talksum Data Stream Router) provides a platform on which powerful data focused solutions may be built to offer functional benefits as well as clear performance for high volume data processing and event routing. For example, a user may monitor more data, faster, while reducing the hardware sprawl typically caused by large volumes of commodity servers. Further, in one embodiment, a log data management solution is built on top of the platform to provide both the functional benefits and efficiency relating to overall hardware footprint and cost.

For example, method 650 may include, but is not limited to, in one embodiment, at block 655, unstructured data from various log sources is received and ingested. At block 660, the data is transformed into a normalized data stream and placed on the data and event routing engine. At block 665, the data is filtered, in real-time, for any number and type of desired values (e.g., errors, elevated CPU usage, device failures, etc.). At block 670, up-to-date counts of the information from the data being filtered are stored as stream stats. At block 675, real-time monitors are keyed off of the desired filters, powering both a real-time dashboard as well as real-time alerts for critical data points. At block 680, the data is transformed and routed, as desired or necessitated, such as to downstream storages, data warehouses, application stacks, remote backups, etc.

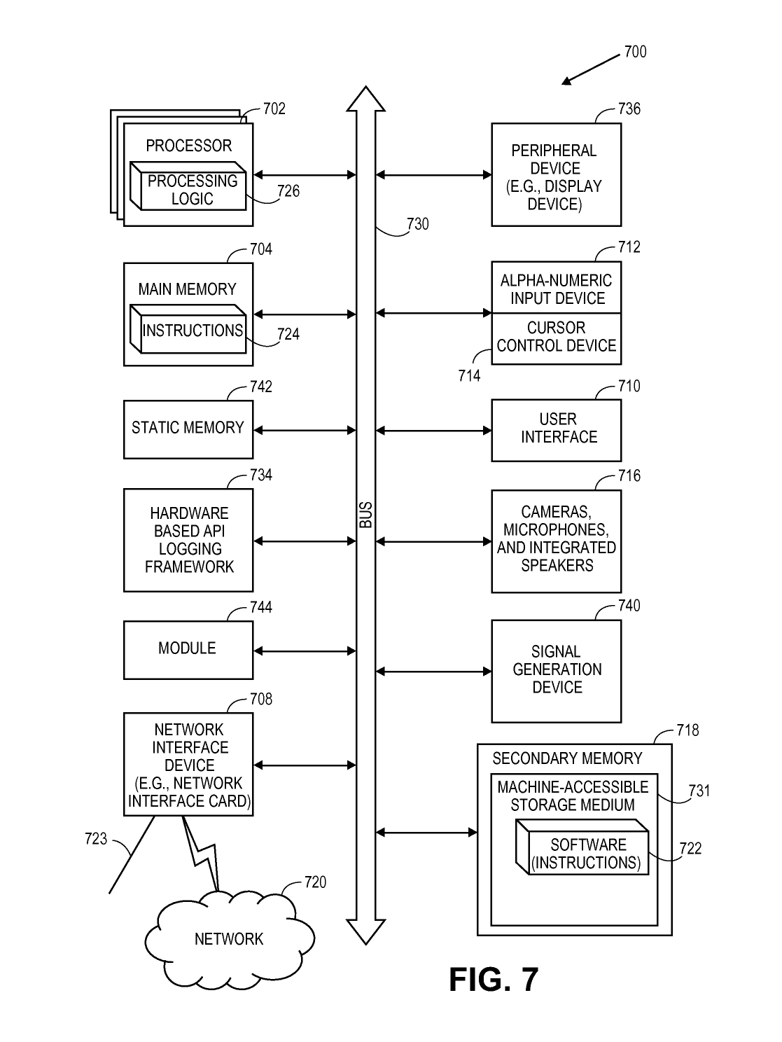

FIG. 7 illustrates a diagrammatic representation of a machine 700 in the form of a computer system, in accordance with one embodiment, within which a set of instructions, for causing the machine 700 to perform any one or more of the methodologies discussed herein, may be executed. Machine 700 is the same as or similar to computing device 100 of FIG. 1. In alternative embodiments, the machine may be connected (e.g., networked) to other machines in a network, such as a cloud-based network, a Local Area Network (LAN), a Wide Area Network (WAN), a Metropolitan Area Network (MAN), a Personal Area Network (PAN), an intranet, an extranet, or the Internet. The machine may operate in the capacity of a server or a client machine in a client-server network environment, or as a peer machine in a peer-to-peer (or distributed) network environment or as a server or series of servers within an on-demand service environment, including an on-demand environment providing multi-tenant database storage services. Certain embodiments of the machine may be in the form of a personal computer (PC), a tablet PC, a set-top box (STB), a Personal Digital Assistant (PDA), a cellular telephone, a web appliance, a server, a network router, switch or bridge, computing system, or any machine capable of executing a set of instructions (sequential or otherwise) that specify actions to be taken by that machine. Further, while only a single machine is illustrated, the term “machine” shall also be taken to include any collection of machines (e.g., computers) that individually or jointly execute a set (or multiple sets) of instructions to perform any one or more of the methodologies discussed herein.

The exemplary computer system 700 includes one or more processors 702, a main memory 704 (e.g., read-only memory (ROM), flash memory, dynamic random access memory (DRAM) such as synchronous DRAM (SDRAM) or Rambus DRAM (RDRAM), etc., static memory 742, such as flash memory, static random access memory (SRAM), volatile but high-data rate RAM, etc.), and a secondary memory 718 (e.g., a persistent storage device including hard disk drives and persistent multi-tenant data base implementations), which communicate with each other via a bus 730. Main memory 704 includes instructions 724 (such as software 722 on which is stored one or more sets of instructions 724 embodying any one or more of the methodologies or functions of mechanism 110 as described with reference to FIG. 1 and other figures described herein) which operate in conjunction with processing logic 726 and processor 702 to perform the methodologies discussed herein.

Processor 702 represents one or more general-purpose processing devices such as a microprocessor, central processing unit, or the like. More particularly, the processor 702 may be a complex instruction set computing (CISC) microprocessor, reduced instruction set computing (RISC) microprocessor, very long instruction word (VLIW) microprocessor, processor implementing other instruction sets, or processors implementing a combination of instruction sets. Processor 702 may also be one or more special-purpose processing devices such as an application specific integrated circuit (ASIC), a field programmable gate array (FPGA), a digital signal processor (DSP), network processor, or the like. Processor 702 is configured to execute the processing logic 726 for performing the operations and functionality of mechanism 110 as described with reference to FIG. 1 and other figures discussed herein.

The computer system 700 may further include a network interface device 708, such as a network interface card (NIC). The computer system 700 also may include a user interface 710 (such as a video display unit, a liquid crystal display (LCD), or a cathode ray tube (CRT)), an alphanumeric input device 712 (e.g., a keyboard), a cursor control device 714 (e.g., a mouse), a signal generation device 740 (e.g., an integrated speaker), and other devices 716 like cameras, microphones, integrated speakers, etc. The computer system 700 may further include peripheral device 736 (e.g., wireless or wired communication devices, memory devices, storage devices, audio processing devices, video processing devices, display devices, etc.). The computer system 700 may further include a hardware-based application programming interface logging framework 734 capable of executing incoming requests for services and emitting execution data responsive to the fulfillment of such incoming requests.

Network interface device 708 may also include, for example, a wired network interface to communicate with remote devices via network cable 723, which may be, for example, an Ethernet cable, a coaxial cable, a fiber optic cable, a serial cable, a parallel cable, etc. Network interface device 708 may provide access to a LAN, for example, by conforming to IEEE 802.11b and/or IEEE 802.11g standards, and/or the wireless network interface may provide access to a personal area network, for example, by conforming to Bluetooth standards. Other wireless network interfaces and/or protocols, including previous and subsequent versions of the standards, may also be supported. In addition to, or instead of, communication via the wireless LAN standards, network interface device 708 may provide wireless communication using, for example, Time Division, Multiple Access (TDMA) protocols, Global Systems for Mobile Communications (GSM) protocols, Code Division, Multiple Access (CDMA) protocols, and/or any other type of wireless communications protocols.

The secondary memory 718 may include a machine-readable storage medium (or more specifically a machine-accessible storage medium) 731 on which is stored one or more sets of instructions (e.g., software 722) embodying any one or more of the methodologies or functions of mechanism 110 as described with reference to FIG. 1 and other figures described herein. The software 722 may also reside, completely or at least partially, within the main memory 704, such as instructions 724, and/or within the processor 702 during execution thereof by the computer system 700, the main memory 704 and the processor 702 also constituting machine-readable storage media. The software 722 may further be transmitted or received over a network 720 via the network interface card 708. Network 720 may be the same as network 250 of FIG. 2. The machine-readable storage medium 731 may include transitory or non-transitory machine-readable storage media.

Portions of various embodiments may be provided as a computer program product, which may include a computer-readable medium having stored thereon computer program instructions, which may be used to program a computer (or other electronic devices) to perform a process according to the embodiments. The machine-readable medium may include, but is not limited to, floppy diskettes, optical disks, compact disk read-only memory (CD-ROM), and magneto-optical disks, ROM, RAM, erasable programmable read-only memory (EPROM), electrically EPROM (EEPROM), magnet or optical cards, flash memory, or other type of media/machine-readable medium suitable for storing electronic instructions.

Modules 744 relating to and/or include components and other features described herein (for example in relation to media mechanism 110 of FIG. 1) can be implemented as discrete hardware components or integrated in the functionality of hardware components such as ASICS, FPGAs, DSPs or similar devices. In addition, modules 744 can be implemented as firmware or functional circuitry within hardware devices. Further, modules 744 can be implemented in any combination hardware devices and software components.

The techniques shown in the figures can be implemented using code and data stored and executed on one or more electronic devices (e.g., an end station, a network element). Such electronic devices store and communicate (internally and/or with other electronic devices over a network) code and data using computer-readable media, such as non-transitory computer-readable storage media (e.g., magnetic disks; optical disks; random access memory; read only memory; flash memory devices; phase-change memory) and transitory computer-readable transmission media (e.g., electrical, optical, acoustical or other form of propagated signals—such as carrier waves, infrared signals, digital signals). In addition, such electronic devices typically include a set of one or more processors coupled to one or more other components, such as one or more storage devices (non-transitory machine-readable storage media), user input/output devices (e.g., a keyboard, a touchscreen, and/or a display), and network connections. The coupling of the set of processors and other components is typically through one or more busses and bridges (also termed as bus controllers). Thus, the storage device of a given electronic device typically stores code and/or data for execution on the set of one or more processors of that electronic device. Of course, one or more parts of an embodiment may be implemented using different combinations of software, firmware, and/or hardware.

Any of the above embodiments may be used alone or together with one another in any combination. Embodiments encompassed within this specification may also include embodiments that are only partially mentioned or alluded to or are not mentioned or alluded to at all in this brief summary or in the abstract. Although various embodiments may have been motivated by various deficiencies with the prior art, which may be discussed or alluded to in one or more places in the specification, the embodiments do not necessarily address any of these deficiencies. In other words, different embodiments may address different deficiencies that may be discussed in the specification. Some embodiments may only partially address some deficiencies or just one deficiency that may be discussed in the specification, and some embodiments may not address any of these deficiencies.

While one or more implementations have been described by way of example and in terms of the specific embodiments, it is to be understood that one or more implementations are not limited to the disclosed embodiments. To the contrary, it is intended to cover various modifications and similar arrangements as would be apparent to those skilled in the art. Therefore, the scope of the appended claims should be accorded the broadest interpretation so as to encompass all such modifications and similar arrangements. It is to be understood that the above description is intended to be illustrative, and not restrictive.

What is claimed is:

1. A method comprising:
receiving, at a computing device, one or more data streams from one or more data sources;
transforming, in real-time, the one or more data streams into one or more normalized data streams, wherein transforming includes performing ingestion of the one or more data streams;
filtering, in real-time, the one or more normalized data streams; and
routing the one or more filtered data streams as real-time output to one or more data systems.

2. The method of claim 1, further comprising performing, in real-time, monitoring of data, wherein monitoring includes monitoring of the reception of the one or more data streams.

3. The method of claim 1, wherein the one or more data sources comprise one or more of system logs, application logs, and computing device logs, wherein the one or more data sources further comprise one or more external sources including one or more of Web applications, customer relationship management (CRM) data sources, system logs, and legacy applications, and wherein the one or more data sources comprise one or more internal sources including public data sources, data feeds, cloud applications, Web logs, and social streams.

4. The method of claim 1, wherein transforming further comprises parsing contents of the one or more data streams, and adding metadata to the contents, wherein the metadata relates to altering and indexing of the contents.

5. The method of claim 1, wherein filtering is perform based on desired values including one or more of errors, elevated processor usage, and device failures.

6. The method of claim 1, wherein the one or more data systems comprise one or more of application storages, data warehouses, and custom outputs, wherein the custom outputs include a real-time dashboard to display the real-time output.

7. A system comprising:
a computing device having a memory to store instructions, and a processing device to execute the instructions, the computing device further having a mechanism to perform one or more operations comprising:
receiving, at a computing device, one or more data streams from one or more data sources;
transforming, in real-time, the one or more data streams into one or more normalized data streams, wherein transforming includes performing ingestion of the one or more data streams;
filtering, in real-time, the one or more normalized data streams; and
routing the one or more filtered data streams as real-time output to one or more data systems.

8. The system of claim 7, wherein the one or more operations comprise performing, in real-time, monitoring of data, wherein monitoring includes monitoring of the reception of the one or more data streams.

9. The system of claim 7, wherein the one or more data sources comprise one or more of system logs, application logs, and computing device logs, wherein the one or more data sources further comprise one or more external sources including one or more of Web applications, customer relationship management (CRM) data sources, system logs, and legacy applications, and wherein the one or more data sources comprise one or more internal sources including public data sources, data feeds, cloud applications, Web logs, and social streams.

10. The system of claim 7, wherein transforming further comprises parsing contents of the one or more data streams, and adding metadata to the contents, wherein the metadata relates to altering and indexing of the contents.

11. The system of claim 7, wherein filtering is perform based on desired values including one or more of errors, elevated processor usage, and device failures.

12. The system of claim 7, wherein the one or more data systems comprise one or more of application storages, data warehouses, and custom outputs, wherein the custom outputs include a real-time dashboard to display the real-time output.

13. At least one machine-readable medium comprising a plurality of instructions that in response to being executed on a computing device, causes the computing device to carry out one or more operations comprising:
receiving, at a computing device, one or more data streams from one or more data sources;
transforming, in real-time, the one or more data streams into one or more normalized data streams, wherein transforming includes performing ingestion of the one or more data streams;
filtering, in real-time, the one or more normalized data streams; and
routing the one or more filtered data streams as real-time output to one or more data systems.

14. The machine-readable medium of claim 13, wherein the one or more operations comprise performing, in real-time, monitoring of data, wherein monitoring includes monitoring of the reception of the one or more data streams.

15. The machine-readable medium of claim 13, wherein the one or more data sources comprise one or more of system logs, application logs, and computing device logs, wherein the one or more data sources further comprise one or more external sources including one or more of Web applications, customer relationship management (CRM) data sources, system logs, and legacy applications, and wherein the one or more data sources comprise one or more internal sources including public data sources, data feeds, cloud applications, Web logs, and social streams.

16. The machine-readable medium of claim 13, wherein transforming further comprises parsing contents of the one or more data streams, and adding metadata to the contents, wherein the metadata relates to altering and indexing of the contents.

17. The machine-readable medium of claim 13, wherein filtering is perform based on desired values including one or more of errors, elevated processor usage, and device failures.

18. The machine-readable medium of claim 13, wherein the one or more data systems comprise one or more of application storages, data warehouses, and custom outputs, wherein the custom outputs include a real-time dashboard to display the real-time output.
